(19) United States
(12) Patent Application Publication
(10) Pub. No.: US 2016/0085758 A1
(43) Pub. Date: Mar. 24, 2016

(54) INTEREST-BASED SEARCH OPTIMIZATION

(71) Applicant: Kaybus, Inc., San Francisco, CA (US)

(72) Inventors: Gazi Mahmud, Berkeley, CA (US); Deanna Liang, San Francisco, CA (US)

(73) Assignee: Kaybus, Inc., San Francisco, CA (US)

(21) Appl. No.: 14/863,389

(22) Filed: Sep. 23, 2015

Related U.S. Application Data
(60) Provisional application No. 62/054,342, filed on Sep. 23, 2014.

(51) Int. Cl. G06F 17/30

(52) U.S. Cl. CPC G06F 17/3053; G06F 17/30867; G06F 17/30528; G06F 17/30554

(57) ABSTRACT

Methods and systems for obtaining optimized search results are provided. A method can include receiving, by a data processing system, a search query including a search term from a user. In response to receiving the search query, the data processing system can identify knowledge elements based on a frequency of occurrence of the search term in each knowledge element. User interest patterns of the user are identified and are stored in a user profile associated with the user. The data processing system ranks the plurality of knowledge elements based on the user interest patterns stored in the user profile associated with the user and the knowledge elements are displayed as the search result according to the ranking.

### CROSS-REFERENCE TO RELATED APPLICATION

The present application is a non-provisional of and claims the benefit and priority of U.S. Provisional Application No. 62/054,342, filed Sep. 23, 2014, entitled “Interest-Based Search Optimization”, the entire contents of which are incorporated herein by reference.

### BACKGROUND

The present disclosure relates generally to knowledge automation. More particularly, methods and devices are disclosed for performing interest-based search optimization of data.

With the vast amount of data content available, users often suffer from information overload. For example, in an enterprise environment, a large corporation may store all of the data that users need to complete their tasks. However, finding the right data for the right user and the location of the data can be challenging. Users may spend a substantial amount of time looking for information regarding particular subject matter. Further, when a user receives a result based on their desired search, a numerous amount of data can be provided to a user that the user may not be interested in. An excessive amount of time would then be needed to analyze and organize the data.

In addition, the data provided to the user may not be complete or additional information may be needed by the user. Therefore, the user may need to find a person who is knowledgeable in the desired subject matter.

Exemplary embodiments address these and other problems.

### SUMMARY

Exemplary embodiments are directed to knowledge automation and more specifically, to interest-based search optimization.

Machine learning can be used to model the content available in an enterprise system (e.g., local storage, remote storage, and cloud storage services, such as SharePoint, Google Drive, Box, etc.) and model the users who request, view, and interact with the content. A user profile can be maintained for each user that includes static and dynamic information of the user. Content can be provided to a user based on the user's search and user profile information. In addition, a user can also modify parameters regarding the type of content that is provided to the user.

In an exemplary embodiment a method can include receiving, by a data processing system, a search query including a search term from a user; in response to receiving the search query, identifying, by the data processing system, a plurality of knowledge elements as a search result to the search query based on a frequency of occurrence of the search term in each knowledge element; identifying user interest patterns of the user, wherein the user interest patterns include static information and dynamic information, wherein the dynamic information is dynamically derived by the data processing system based on prior search queries submitted by the user and knowledge elements that the user has consumed, and wherein the user interest patterns are stored in a user profile associated with the user; ranking, by the data processing system, the plurality of knowledge elements based on the user interest patterns stored in the user profile associated with the user; and displaying the plurality of knowledge elements according to the ranking as the search result.

In another exemplary embodiment, a non-transitory computer-readable storage medium can store a plurality of instructions executable by one or more processors, the plurality of instructions including receiving a search query including a search term from a user; in response to receiving the search query, identifying a plurality of knowledge elements as a search result to the search query based on a frequency of occurrence of the search term in each knowledge element; identifying user interest patterns of the user, wherein the user interest patterns include static information and dynamic information, wherein the dynamic information is dynamically derived by the data processing system based on prior search queries submitted by the user and knowledge elements that the user has consumed, and wherein the user interest patterns are stored in a user profile associated with the user; ranking the plurality of knowledge elements based on the user interest patterns stored in the user profile associated with the user; and displaying the plurality of knowledge elements according to the ranking as the search result.

In another exemplary embodiment, a system can include one or more processors; and a memory coupled with and readable by the one or more processors, the memory configured to store a set of instructions which, when executed by the one or more processors, causes the one or more processors to receive a search query including a search term from a user; in response to receiving the search query, identify a plurality of knowledge elements as a search result to the search query based on a frequency of occurrence of the search term in each knowledge element; identify user interest patterns of the user, wherein the user interest patterns include static information and dynamic information, wherein the dynamic information is dynamically derived by the data processing system based on prior search queries submitted by the user and knowledge elements that the user has consumed, and wherein the user interest patterns are stored in a user profile associated with the user; rank the plurality of knowledge elements based on the user interest patterns stored in the user profile associated with the user; and display the plurality of knowledge elements according to the ranking as the search result.

A better understanding of the exemplary embodiments may be gained with reference to the following detailed description and the accompanying drawings.

### BRIEF DESCRIPTION OF THE DRAWINGS

The disclosure will be readily understood by the following detailed description in conjunction with the accompanying drawings, wherein like reference numerals designate like elements, and in which:

FIG. 1 illustrates an environment in which a knowledge automation system that provides interest-based search optimization can be implemented, according to some exemplary embodiments.

FIG. 2 illustrates a flow diagram depicting some of the processing that can be performed by a knowledge automation system, according to some exemplary embodiments.

FIG. 3 illustrates a block diagram of a knowledge automation system, according to some exemplary embodiments.

FIG. 4 illustrates a user profile, according to some exemplary embodiments.

FIG. 5 illustrates a block diagram of a knowledge automation system including a contextualized searcher, according to some exemplary embodiments.

FIG. 6 illustrates a flow diagram of a method of performing a contextual search, according to some exemplary embodiments.

FIG. 7 illustrates a graphical user interface displaying a contextual search, according to some exemplary embodiments.

FIG. 8 illustrates a graphical user interface for selecting user interest levels, according to some exemplary embodiments.

FIG. 9 illustrates a diagram of a user's interest level in identified content and a graphical user interface for adjusting the interest levels, according to some exemplary embodiments.

FIG. 10 illustrates a flow diagram of a method of adjusting user interest levels, according to some exemplary embodiments.

FIG. 11 illustrates a flow diagram of a method of performing a contextual search including expert information, according to some exemplary embodiments.

FIG. 12 illustrates a graphical user interface displaying knowledge entities including expert information, according to some exemplary embodiments.

FIG. 13 depicts a block diagram of a computing system, according to some exemplary embodiments.

FIG. 14 depicts a block diagram of a service provider system, according to some exemplary embodiments.

### DETAILED DESCRIPTION

The present disclosure relates generally to knowledge automation and performing a contextualized search for one or more search terms. The search can take user interest patterns into account in order to provide a user with search results that are most relative to the user. Further, one or more experts of the search term can also be identified with the search results.

Substantial amounts of data (e.g., data files such as documents, emails, images, code, and other content, etc.) may be available to users in an enterprise. These users may rely on information contained in the data to assist them in performing their tasks. The users may also rely on information contained in the data to generate useful knowledge that is consumed by other users. For example, a team of users may take technical specifications related to a new product release, and generate a set of training materials for the technicians who will install the new product. However, the large quantities of data available to these users may make it difficult to identify the right information to use.

Machine learning techniques can analyze content at scale (e.g., enterprise-wide and beyond) and identify patterns of what is most useful to which users. Machine learning can be used to model both the content accessible by an enterprise system (e.g., local storage, remote storage, and cloud storage services, such as SharePoint, Google Drive, Box, etc.), and the users who request, view, and otherwise interact with the content. Based on a user's profile and how the user interacts with the available content, each user's interests, expertise, and peers can be modeled. The data content can then be matched to the appropriate users who would most likely be interested in that content. In this manner, the right knowledge can be provided to the right users at the right time. This not only improves the efficiency of the users in identifying and consuming knowledge relevant for each user, but also improves the efficiency of computing systems by freeing up computing resources that would otherwise be consumed by efforts to search and locate the right knowledge, and allowing these computing resources to be allocated for other tasks.

### I. Architecture Overview

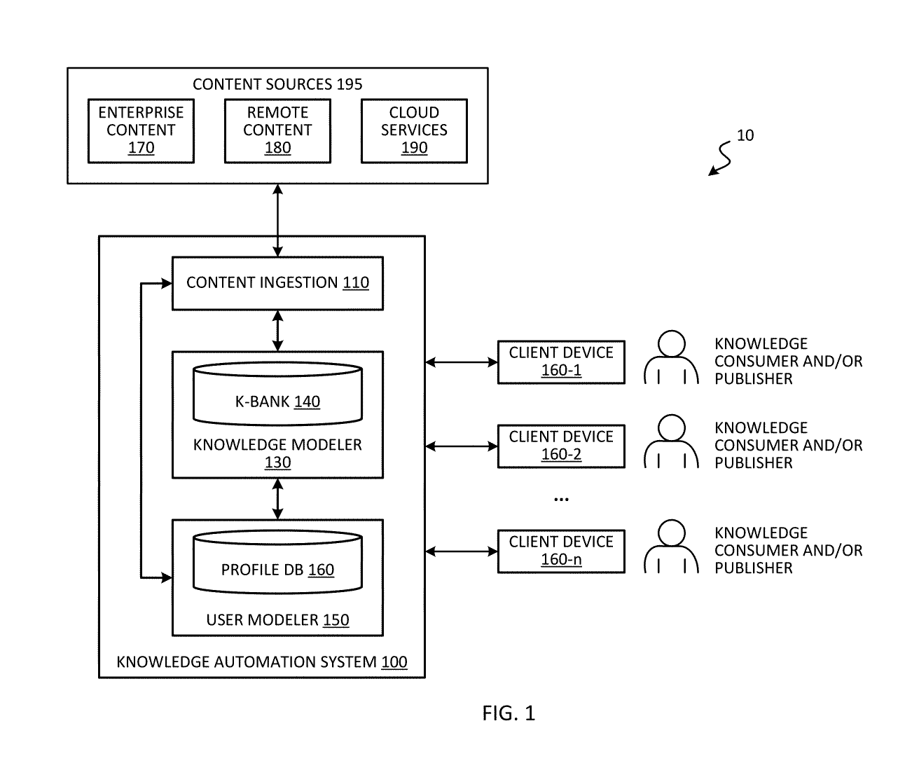

FIG. 1 illustrates an environment 10 in which a knowledge automation system 100 system that provides interest-based search optimization can be implemented, according to some exemplary embodiments. As shown in FIG. 1, a number of client devices 160-1, 160-2, . . . 160-n can be used by a number of users to access services provided by knowledge automation system 100. The client devices may be of various different types, including, but not limited to personal computers, desktops, mobile or handheld devices such as laptops, smart phones, tablets, etc., and other types of devices. Each of the users can be a knowledge consumer who accesses knowledge from knowledge automation system 100, or a knowledge publisher who publishes or generates knowledge in knowledge automation system 100 for consumption by other users. In some embodiments, a user can be both a knowledge consumer or a knowledge publisher, and a knowledge consumer or a knowledge publisher may refer to a single user or a user group that includes multiple users.

Knowledge automation system 100 can be implemented as a data processing system, and may discover and analyze content from one or more content sources 195 stored in one or more data repositories, such as a databases, file systems, management systems, email servers, object stores, and/or other repositories or data stores. In some embodiments, client devices 160-1, 160-2, . . . 160-n can access the services provided by knowledge automation system 100 through a network such as the Internet, a wide area network (WAN), a local area network (LAN), an Ethernet network, a public or private network, a wired network, a wireless network, or a combination thereof. Content sources 195 may include enterprise content 170 maintained by an enterprise, remote content 180 maintained at one or more remote locations (e.g., the Internet), cloud services content 190 maintained by cloud storage service providers, etc. Content sources 195 can be accessible to knowledge automation system 100 through a local interface, or through a network interface connecting knowledge automation system 100 to the content sources via one or more of the networks described above. In some embodiments, one or more of the content sources 195, one or more of the client devices 160-1, 160-2, . . . 160-n, and knowledge automation system 100 can be part of the same network, or can be part of different networks.

Each client device can request and receive knowledge automation services from knowledge automation system 100. Knowledge automation system 100 may include various software applications that provide knowledge-based services to the client devices. In some embodiments, the client devices can access knowledge automation system 100 through a thin client or web browser executing on each client device. Such software as a service (SaaS) models allow multiple different clients (e.g., clients corresponding to different customer entities) to receive services provided by the software applications without installing, hosting, and maintaining the software themselves on the client device.

Knowledge automation system 100 may include a content ingestion module 110, a knowledge modeler 130, and a user modeler 150, which collectively may extract information from data content accessible from content sources 195, derive knowledge from the extracted information, and provide recommendation of particular knowledge to particular clients. Knowledge automation system 100 can provide a number of knowledge services based on the ingested content. For example, a corporate dictionary can automatically be generated, maintained, and shared among users in the enterprise. A user's interest patterns (e.g., the content the user typically views) can be identified and used to provide personalized search results to the user. In some embodiments, user requests can be monitored to detect missing content, and knowledge automation system 100 may perform knowledge brokering to fill these knowledge gaps. In some embodiments, users can define knowledge campaigns to generate and distribute content to users in an enterprise, monitor the usefulness of the content to the users, and make changes to the content to improve its usefulness. Knowledge automation systems are described in greater detail in U.S. application Ser. No. 14/819,698 entitled “Knowledge Automation System Adaptive Feedback,” filed on Aug. 6, 2015, which is incorporated by reference.

Content ingestion module 110 can identify and analyze enterprise content 170 (e.g., files and documents, other data such as e-mails, web pages, enterprise records, code, etc. maintained by the enterprise), remote content 180 (e.g., files, documents, and other data, etc. stored in remote databases), cloud services content 190 (e.g., files, documents, and other data, etc. accessible form the cloud), and/or content from other sources. For example, content ingestion module 110 may crawl or mine one or more of the content sources to identify the content stored therein, and/or monitor the content sources to identify content as they are being modified or added to the content sources. Content ingestion module 110 may parse and synthesize the content to identify the information contained in the content and the relationships of such information. In some embodiments, ingestion can include normalizing the content into a common format, and storing the content as one or more knowledge units in a knowledge bank 140 (e.g., a knowledge data store). In some embodiments, content can be divided into one or more portions during ingestion. For example, a new product manual may describe a number of new features associated with a new product launch. During ingestion, those portions of the product manual directed to the new features may be extracted from the manual and stored as separate knowledge units. These knowledge units can be tagged or otherwise be associated with metadata that can be used to indicate that these knowledge units are related to the new product features. In some embodiments, content ingestion module 110 may also perform access control mapping to restrict certain users from being able to access certain knowledge units.

Knowledge modeler 130 may analyze the knowledge units generated by content ingestion module 120, and combine or group knowledge units together to form knowledge packs. A knowledge pack may include various related knowledge units (e.g., several knowledge units related to a new product launch can be combined into a new product knowledge pack). In some embodiments, a knowledge pack can be formed by combining other knowledge packs, or a mixture of knowledge unit(s) and knowledge pack(s). The knowledge packs can be stored in knowledge bank 140 together with the knowledge units, or be stored separately. Knowledge modeler 130 may automatically generate knowledge packs by analyzing the topics covered by each knowledge unit, and combining knowledge units covering a similar topic into a knowledge pack. In some embodiments, knowledge modeler 130 may allow a user (e.g., a knowledge publisher) to build custom knowledge packs, and to publish custom knowledge packs for consumption by other users.

User modeler 150 may monitor user activities on the system as they interact with the knowledge bank 140 and the knowledge units and knowledge packs stored therein (e.g., the user's search history, knowledge units and knowledge packs consumed, knowledge packs published, time spent viewing each knowledge pack and/or search results, etc.). User modeler 150 may maintain a profile database 160 that stores user profiles for users of knowledge automation system 100. User modeler 150 may augment the user profiles with behavioral information based on user activities. By analyzing the user profile information, user modeler 150 can match a particular user to knowledge packs that the user may be interested in, and provide the recommendations to that user. For example, if a user has a recent history of viewing knowledge packs directed to a wireless networks, user modeler module 150 may recommend other knowledge packs directed to wireless networks to the user. As the user interacts with the system, user modeler 150 can dynamically modify the recommendations based on the user's behavior. User modeler 150 may also analyze search results performed by users to determine the effectiveness of the search results successful (e.g., did the user select and use the results), and to identify potential knowledge gaps in the system. In some embodiments, user modeler 150 may provide these knowledge gaps to content ingestion module 310 to find useful content to fill the knowledge gaps.

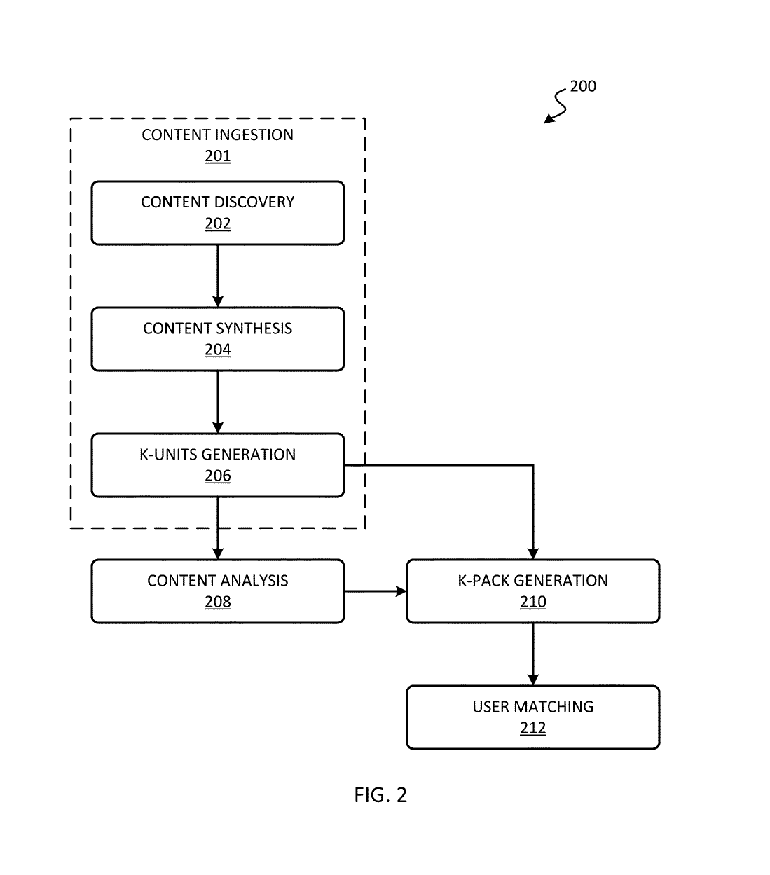

FIG. 2 illustrates a simplified flow diagram 200 depicting some of the processing that can be performed, for example, by a knowledge automation system, according to some exemplary embodiments. The processing depicted in FIG. 2 may be implemented in software (e.g., code, instructions, program) executed by one or more processing units (e.g., processors, cores), hardware, or combinations thereof. The software may be stored in memory (e.g., on a non-transitory computer-readable storage medium such as a memory device).

The processing illustrated in flow diagram 200 may begin with content ingestion 201. Content ingestion 201 may include content discovery 202, content synthesis 204, and knowledge units generation 206. Content ingestion 201 can be initiated at block 202 by performing content discovery to identify and discover data content (e.g., data files) at one or more data sources such as one or more data repositories. At block 204, content synthesis is performed on the discovered data content to identify information contained in the content. The content synthesis may analyze text, patterns, and metadata variables of the data content.

At block 206, knowledge units are generated from the data content based on the synthesized content. Each knowledge unit may represent a chunk of information that covers one or more related subjects. The knowledge units can be of varying sizes. For example, each knowledge unit may correspond to a portion of a data file (e.g., a section of a document) or to an entire data file (e.g., an entire document, an image, etc.). In some embodiments, multiple portions of data files or multiple data files can also be merged to generate a knowledge unit. By way of example, if an entire document is focused on a particular subject, a knowledge unit corresponding to the entire document can be generated. If different sections of a document are focused on different subjects, then different knowledge units can be generated from the different sections of the document. A single document may also result in both a knowledge unit generated for the entire document as well as knowledge units generated from portions of the document. As another example, various email threads relating to a common subject can be merged into a knowledge unit. The generated knowledge units are then indexed and stored in a searchable knowledge bank.

At block 208, content analysis is performed on the knowledge units. The content analysis may include performing semantics and linguistics analyses and/or contextual analysis on the knowledge units to infer concepts and topics covered by the knowledge units. Key terms (e.g., keywords and key phrases) can be extracted, and each knowledge unit can be associated with a term vector of key terms representing the content of the knowledge unit. In some embodiments, named entities can be identified from the extracted key terms. Examples of named entities may include place names, people's names, phone numbers, social security numbers, business names, dates and time values, etc. Knowledge units covering similar concepts can be clustered, categorized, and tagged as pertaining to a particular topic or topics. Taxonomy generation can also be performed to derive a corporate dictionary identifying key terms and how the key terms are used within an enterprise.

At block 210, knowledge packs are generated from individual knowledge units. The knowledge packs can be automatically generated by combining knowledge units based on similarity mapping of key terms, topics, concepts, metadata such as authors, etc. In some embodiments, a knowledge publisher can also access the knowledge units generated at block 206 to build custom knowledge packs. A knowledge map representing relationships between the knowledge packs can also be generated to provide a graphical representation of the knowledge corpus in an enterprise.

At block 212, the generated knowledge packs are mapped to knowledge consumers who are likely to be interested in the particular knowledge packs. This mapping can be performed based on information about the user (e.g., user's title, job function, etc.), as well as learned behavior of the user interacting with the system (e.g., knowledge packs that the user has viewed and consumed in the past, etc.). The user mapping can also take into account user feedback (e.g., adjusting relative interest levels, search queries, ratings, etc.) to tailor future results for the user. Knowledge packs mapped to a particular knowledge consumer can be distributed to the knowledge consumer by presenting the knowledge packs on a recommendations page for the knowledge consumer.

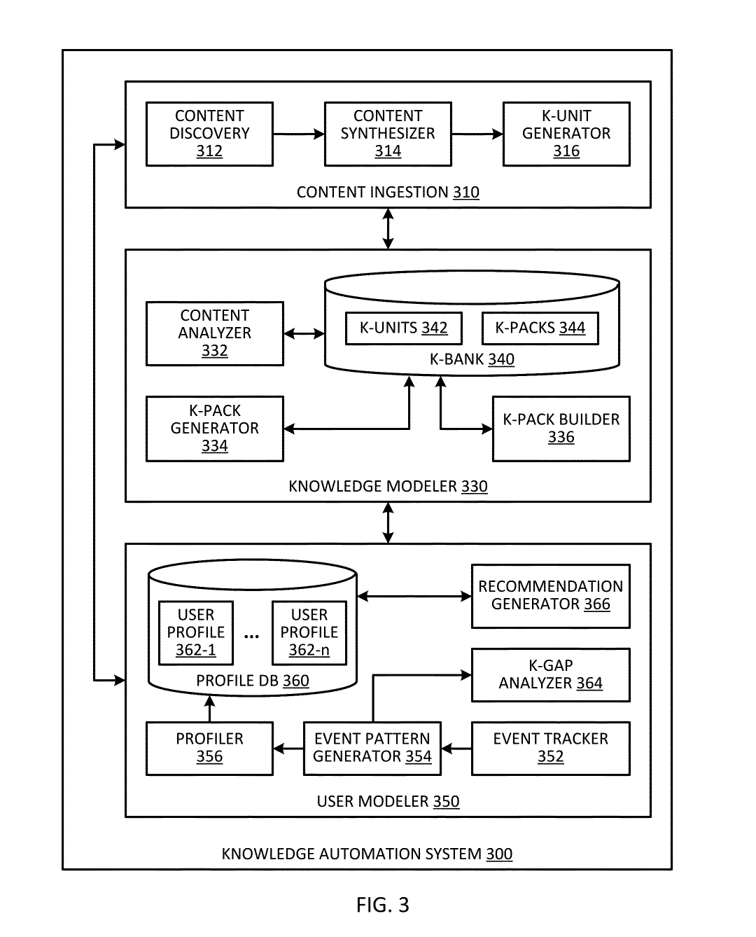

FIG. 3 illustrates a more detailed block diagram of a knowledge automation system 300, according to some exemplary embodiments. Knowledge automation system 300 can be implemented as a data processing system, and may include a content ingestion module 310, a knowledge modeler 330, and a user modeler 350. In some embodiments, the processes performed by knowledge automation system 300 can be performed in real-time. For example, as the data content or knowledge corpus available to the knowledge automation system changes, knowledge automation system 300 may react in real-time and adapt its services to reflect the modified knowledge corpus.

Content ingestion module 310 may include a content discovery module 312, a content synthesizer 314, and a knowledge unit generator 316. Content discovery module 312 interfaces with one or more content sources to discover contents stored at the content sources, and to retrieve the content for analysis. In some embodiments, knowledge automation system 300 can be deployed to an enterprise that already has a pre-existing content library. In such scenarios, content discovery module 312 can crawl or mine the content library for existing data files, and retrieve the data files for ingestion. In some embodiments, the content sources can be continuously monitored to detect the addition, removal, and/or updating of content. When new content is added to a content source or a pre-existing content is updated or modified, content discovery module 312 may retrieve the new or updated content for analysis. New content may result in new knowledge units being generated, and updated content may result in modifications being made to affected knowledge units and/or new knowledge units being generated. When content is removed from a content source, content discovery module 312 may identify the knowledge units that were derived from the removed content, and either remove the affected knowledge units from the knowledge bank, or tag the affected knowledge units as being potentially invalid or outdated.

Content synthesizer 314 receives content retrieved by content discovery module 312, and synthesizes the content to extract information contained in the content. The content retrieved by content discovery module 312 may include different types of content having different formats, storage requirements, etc. As such, content synthesizer 314 may convert the content into a common format for analysis. Content synthesizer 314 may identify key terms (e.g., keywords and/or key phrases) in the content, determine a frequency of occurrence of the key terms in the content, and determining locations of the key terms in the content. In addition to analyzing information contained in the content, content synthesizer 314 may also extract metadata associated with the content (e.g., author, creation date, title, revision history, etc.).

Knowledge unit generator 314 may then generate knowledge units from the content based on patterns of key terms used in the content and the metadata associated with the content.

For example, if a document has a large frequency of occurrence of a key term in the first three paragraphs of the document, but a much lower frequency of occurrence of that same key term in the remaining portions of the document, the first three paragraphs of the document can be extracted and formed into a knowledge unit. As another example, if there is a large frequency of occurrence of a key term distributed throughout a document, the entire document can be formed into a knowledge unit. The generated knowledge units are stored in a knowledge bank 340, and indexed based on the identified key terms and metadata to make the knowledge units searchable in knowledge bank 340.

Knowledge modeler 330 may include content analyzer 332, knowledge bank 340, knowledge pack generator 334, and knowledge pack builder 336. Content analyzer 332 may perform various types of analyses on the knowledge units to model the knowledge contained in the knowledge units. For example, content analyzer 332 may perform key term extraction and entity (e.g., names, companies, organizations, etc.) extraction on the knowledge units, and build a taxonomy of key terms and entities representing how the key terms and entities are used in the knowledge units. Content analyzer 332 may also perform contextual, sematic, and linguistic analyses on the knowledge units to infer concepts and topics covered by the knowledge units. For example, natural language processing can be performed on the knowledge units to derive concepts and topics covered by the knowledge units. Based on the various analyses, content analyzer 332 may derive a term vector for each knowledge unit to represent the knowledge contained in each knowledge unit. The term vector for a knowledge unit may include key terms, entities, and dates associated with the knowledge unit, topic and concepts associated with the knowledge unit, and/or other metadata such as authors associated with the knowledge unit. Using the term vectors, content analyzer 332 may perform similarity mapping between the knowledge units to identify knowledge units that cover similar topics or concepts.

Knowledge pack generator 334 may analyze the similarity mapping performed by content analyzer 332, and automatically form knowledge packs by combining similar knowledge units. For example, knowledge units that share at least five common key terms can be combined to form a knowledge pack. As another example, knowledge units covering the same topic can be combined to form a knowledge pack. In some embodiments, a knowledge pack may include other knowledge packs, or a combination of knowledge pack(s) and knowledge unit(s). For example, knowledge packs that are viewed and consumed by the a set of users can be combined into a knowledge pack. The generated knowledge packs can be tagged with their own term vectors to represent the knowledge contain in the knowledge pack, and be stored in knowledge bank 340.

Knowledge pack builder 336 may provide a user interface to allow knowledge publishers to create custom knowledge packs. Knowledge pack builder 336 may present a list of available knowledge units to a knowledge publisher to allow the knowledge publisher to select specific knowledge units to include in a knowledge pack. In this manner, a knowledge publisher can create a knowledge pack targeted to specific knowledge consumers. For example, a technical trainer can create a custom knowledge pack containing knowledge units covering specific new features of a produce to train a technical support staff. The custom knowledge packs can also be tagged and stored in knowledge bank 340.

Knowledge bank 340 is used for storing knowledge units 342 and knowledge packs 344. Knowledge bank 340 can be implemented as one or more data stores. Although knowledge bank 340 is shown as being local to knowledge automation system 300, in some embodiments, knowledge bank 340, or part of knowledge bank 340 can be remote to knowledge automation system 300. In some embodiments, frequently requested, or otherwise highly active or valuable knowledge units and/or knowledge packs, can be maintained in in a low latency, multiple redundancy data store. This makes the knowledge units and/or knowledge packs quickly available when requested by a user. Infrequently accessed knowledge units and/or knowledge packs may be stored separately in slower storage.

Each knowledge unit and knowledge pack can be assigned an identifier that is used to identify and access the knowledge unit or knowledge pack. In some embodiments, to reduce memory usage, instead of storing the actual content of each knowledge unit in knowledge bank 340, the knowledge unit identifier referencing the knowledge unit and the location of the content source of the content associated with the knowledge unit can be stored. In this manner, when a knowledge unit is accessed, the content associated with the knowledge unit can be retrieved from the corresponding content source. For a knowledge pack, an knowledge pack identifier referencing the knowledge pack, and the identifiers and locations of the knowledge units and/or knowledge packs that make up the knowledge pack can be stored. Thus, a particular knowledge pack can be thought of as a container or a wrapper object for the knowledge units and/or knowledge packs that make up the particular knowledge pack. In some embodiments, knowledge bank 340 may also store the actual content of the knowledge units, for example, in a common data format. In some embodiments, knowledge bank 340 may selectively store some content while not storing other content (e.g., content of new or frequently accessed knowledge units can be stored, whereas stale or less frequently accessed content are not stored in knowledge bank 340).

Knowledge units 342 can be indexed in knowledge bank 340 according to key terms contained in the knowledge unit (e.g., may include key words, key phrases, entities, dates, etc. and number of occurrences of such in the knowledge unit) and/or associated metadata (e.g., author, location such as URL or identifier of the content, date, language, subject, title, file or document type, etc.). In some embodiments, the metadata associated with a knowledge unit may also include metadata derived by knowledge automation system 300. For example, this may include information such as access control information (e.g., which user or user group can view the knowledge unit), topics and concepts covered by the knowledge unit, knowledge consumers who have viewed and consumed the knowledge unit, knowledge packs that the knowledge unit is part of, time and frequency of access, etc.). Knowledge packs 344 stored in knowledge bank may include knowledge packs automatically generated by the system, and/or custom knowledge packs created by users (e.g., knowledge publishers). Knowledge packs 344 may also be indexed in a similar manner as for knowledge packs described above. In some embodiments, the metadata for a knowledge pack may include additional information that a knowledge unit may not have. For example, these may include a category type (e.g., newsletter, emailer, training material, etc.), editors, target audience, etc.

In some embodiments, a term vector can be associated with each knowledge element (e.g., a knowledge unit and/or a knowledge pack). The term vector may include key terms, metadata, and derived metadata associated with the each knowledge element. In some embodiments, instead of including all key terms present in a knowledge element, the term vector may include a predetermined number of key terms with the highest occurrence count in the knowledge element (e.g., the top five key terms in the knowledge element, etc.), or key terms that have greater than a minimum number of occurrences (e.g., key terms that appear more than ten times in a knowledge element, etc.).

User modeler 350 may include an event tracker 352, an event pattern generator 354, a profiler 356, a knowledge gap analyzer 364, a recommendations generator 366, and a profile database 360 that stores a user profile for each user of knowledge automation system 300. Event tracker 352 monitors user activities and interactions with knowledge automation system 300. For example, the user activities and interactions may include knowledge consumption information such as which knowledge unit or knowledge pack that a user has viewed, the length of time spent on the knowledge unit/pack, and when did the user access the knowledge unit/pack. The user activities and interactions tracked by event tracker 352 may also include search queries performed by the users, and user responses to the search results (e.g., number and frequency of similar searches performed by the same user and by other users, amount of time a user spends on reviewing the search result, how deep into a result list the user traversed, the number of items in the result list the user accessed and length of time spend on each item, etc.). If a user is a knowledge publisher, event tracker 352 may also track the frequency that the knowledge publisher publishes, when the knowledge publisher publishes, and topics or categories that the knowledge publisher publishes in, etc.

Event pattern generator 354 may analyze the user activities and interactions tracked by event tracker 352, and derive usage or event patterns for users or user groups. Profiler 356 may analyze these patterns and augment the user profiles stored in profile database 360. For example, if a user has a recent history of accessing a large number of knowledge packs relating to a particular topic, profiler 356 may augment the user profile of this user with an indication that this user has an interest in the particular topic. For patterns relating to search queries, knowledge gap analyzer 364 may analyze the search query patterns and identify potential knowledge gaps relating to certain topics in which useful information may be lacking in the knowledge corpus. Knowledge gap analyzer 364 may also identify potential content sources to fill the identified knowledge gaps. For example, a potential content source that may fill a knowledge gap can be a knowledge publisher who frequently publishes in a related topic, the Internet, or some other source from which information pertaining to the knowledge gap topic can be obtained.

Recommendations generator 366 may provide a knowledge mapping service that provides knowledge pack recommendations to knowledge consumers of knowledge automation system 300. Recommendations generator 366 may compare the user profile of a user with the available knowledge packs in knowledge bank 340, and based on the interests of the user, recommend knowledge packs to the user that may be relevant for the user. For example, when a new product is released and a product training knowledge pack is published for the new product, recommendations generator 366 may identify knowledge consumers who are part of a sales team, and recommend the product training knowledge pack to those users. In some embodiments, recommendations generator 366 may generate user signatures form the user profiles and knowledge signatures from the knowledge elements (e.g., knowledge units and/or knowledge packs), and make recommendations based on comparisons of the user signatures to the knowledge signatures. The analysis can be performed by recommendations generator 366, for example, when a new knowledge pack is published, when a new user is added, and/or when the user profile of a user changes.

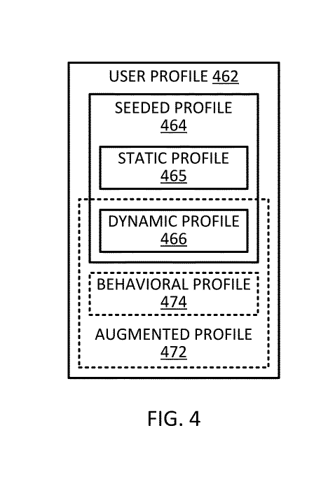

FIG. 4 illustrates a user profile 462 associated with a user of a knowledge automation system, according to some exemplary embodiments. User profile 462 can be stored, for example, in a user profile database. User profile 462 may include a seeded profile 464, and an augmented profile 472. Seeded profile 464 may include information about the user that is seeded or provided to the system when the user enrolls or registers in the knowledge automation system. For example, seeded profile 464 may include information such as the name of the user, the location and/or time zone of the user, role and/or job function of the user, work group the user is part of, experience of the user, expertise of the user, etc. Seeded profile 464 may include a static profile 465 that is generally static and does not change often for a user. For example, information such as name, location and/or time zone, and role and/or job function, etc. may be part of the static profile 465. Seeded profile 464 may also include a dynamic profile 466 that includes seeded information about a user that may change over time. For example, information such as work group, experience, and expertise, etc. can be part of dynamic profile 466, because the user's experience and expertise may grow over time, and the user can be placed on different teams over time.

Augmented profile 472 may include information about the user that the knowledge automation system modifies or adds to user profile 462. Augmented profile 472 may include information about the user that the knowledge automation system learns over time via monitoring of the user's activities and interactions with the system. Augmented profile 472 may include dynamic profile 466 that overlaps with seeded profile 464. For example, if the user has been consuming a large amount of knowledge about a particular topic, the knowledge automation system may add that topic to the user's seeded expertise. As another example, as the user completes one project and is placed on a different project team, the knowledge automation system may modify the seeded work group of the user to reflect this change.

Augmented profile 472 also includes behavioral profile 474 that represents the user's usage patterns in the knowledge automation system. For example, behavioral profile 474 may include information such as topics and/or publishers of knowledge packs that the user consumes, categories of knowledge packs that the user consumes, key terms that the user searches for, topics of knowledge packs that the user publishes, etc. Based on the user's activities and interactions with the system, the knowledge automation system may infer specific topics that the user may be interested in. In some embodiments, the user may be allowed to adjust the user's interest level of the topics that the knowledge automation system inferred, and this information can be included in behavioral profile 474.

In some embodiments, the knowledge automation system may group multiple users into a user group. A user group can be formed based on common attributes of the users. For example, users in the same work group can be formed into a user group, or users at the same location or time zone can be formed into a user group, etc. In some embodiments, a user group can be formed based on common behaviors of the users. For example, if a set of users often consumes knowledge packs on a particular topic, these users can be formed into a user group. As another example, if a set of users often publishes a particular category of knowledge packs, these users can be formed into a user group. It should be understood that a user can belong to more than one user group.

### II. Contextual Search

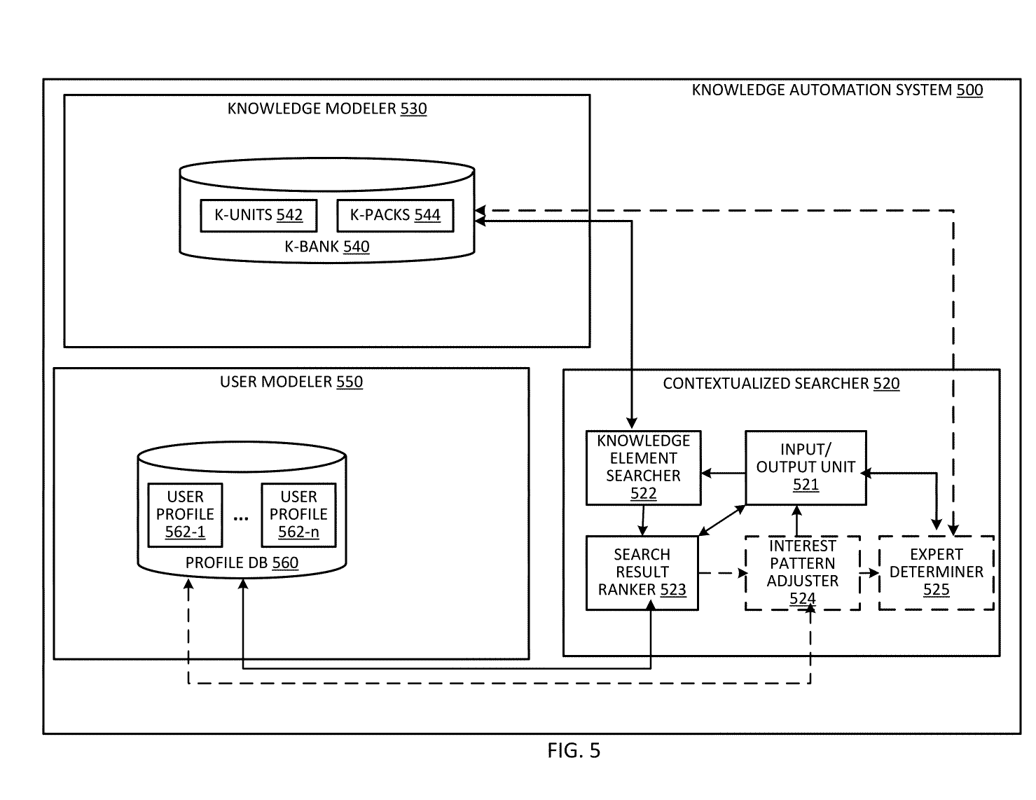

FIG. 5 illustrates a block diagram of a knowledge automation system 500 including a contextualized searcher 520, a knowledge modeler 530 and a user modeler 550, according to some exemplary embodiments.

Knowledge modeler 530 includes similar elements to that of knowledge modeler 130 and/or knowledge modeler 330. As shown in FIG. 5, the knowledge modeler 530 includes knowledge units 542 and knowledge packs 544 that are stored in a knowledge bank 540. User modeler 550 includes elements similar to that of user modeler 150 and/or user modeler 330. As shown in FIG. 5, the user modeler 550 can include user profiles 562-1 to 562-n that are stored in a profile database 560.

Contextualized searcher 520 can be used to search for one or more knowledge elements (e.g. knowledge units and/or knowledge packs) in response to a search query input by a user. Contextualized searcher 520 can include an input unit 521, a knowledge element searcher 522, and a search result ranker 523. In addition, the contextualized searcher 520 can include an interest pattern adjuster 524 and an expert determiner 525.

When a user wants to find information directed to particular subject matter, a user can input one or more search terms related to the subject matter in the input/output unit 521. The knowledge element searcher 522 will search for knowledge elements that include the desired one or more search terms. The knowledge element searcher 522 can search the knowledge bank 540 for knowledge elements directed to the desired one or more search terms and identify knowledge elements in the knowledge bank 340 which contain the most instances of the one or more search terms. That is, the knowledge element searcher 522 will search for knowledge elements in which the desired search term appears most frequently.

The knowledge elements that can be included in the search result can be knowledge elements that have a predefined threshold number of occurrences of the search term in the knowledge element. For example, a predefined threshold number can be three or more. Therefore, knowledge elements which contain three or more instances of the search term will be identified. Alternatively, knowledge elements which contain the most occurrences of a search term can be provided in a search result. For example, a user can set the search results so that the top twenty knowledge elements which contain the search term are provided as a search result.

The knowledge elements that were identified by the knowledge element searcher 522 are ranked by the search result ranker 523. The search result ranker 523 will rank the knowledge elements according to the user profile and specifically according to interest patterns of the user obtained from the user's profile. In some embodiments, the ranking can be performed using, for example, a term frequency-inverse document frequency (TF/IDF) ranking algorithm.

The user profile can be stored in, for example, profile database 560. The interest patterns of the user can include static and dynamic information about the user as well as user defined information. Static information about the user can include user metadata, such as a user's location (e.g., city, state, office building), a user's job function (e.g. team leader, assistant), and a group the user belongs to (e.g., engineering group).

Dynamic information can include machine learned information, such as the most frequently viewed categories of content, frequently followed content publishers, and the most interesting key phrases based on search patterns and content consumption of the user. Additional dynamic information can include user activity such as knowledge elements the user has published.

Dynamic information can also include user metadata such as user interests of peers of the user, interests of user's in a user's department, and trending topics among a user's peers. For example, it can be determined that certain terms are of interest to other users who work with the user or are in the same department as the user. Therefore, it can be machine learned that certain key terms which are of interest to the user's peers or to other members of the user's department, may be of interest to the user.

User defined information can include a user adjusted preferred list of categories, a user adjusted preferred list of knowledge publishers, and/or user adjusted prefer list of key terms. For example, prior to or after a search is performed, a user can select particular categories of knowledge, knowledge publishers, and terms which are of most interest to the user.

The user interest patterns which are included in a user profile can vary. Different types of information, whether static or dynamic, can be included in a user profile in order to provide optimized search results to a user.

Further, patterns can be identified for a specific user. In some embodiments, patterns can be identified for a group of users. Patterns can be identified along multiple dimensions. Categories of content, a key term or group of key terms can each be modeled as a user interest dimension.

For example, a user may be interested in engineering knowledge packs (one dimension), but may frequently read engineering knowledge packs by User B (a second dimension), or engineering knowledge packs by User B that include a particular keyword (a third dimension), and so on. For each identified dimension, a weight can be assigned that indicates the user's interest in that dimension. The weights for each dimension may be further customized by the user, as described below. The search results can be ranked based on weighted fields that correspond with each of the user interest dimensions. The ranked knowledge elements can be provided to the user via the input/output unit 521.

Prior to conducting a search or subsequent to a search, a user may want to adjust the user's interest patterns. For example, a user may determine that the search results being retrieved are not adequate. The interest pattern adjuster 524 can be used to adjust a user's interest patterns. Adjustments to the user's interest patterns can be stored in the user's profile.

Further, a user may desire information regarding knowledge publishers or knowledge consumers who are experts with respect to a particular search term. An expert can be a knowledge publisher and/or a knowledge consumer who has published or consumed a threshold number of knowledge elements or a knowledge publisher and/or a knowledge consumer who has published or consumed the top-ranking knowledge elements. The expert determiner 525 can retrieve knowledge publisher and/or knowledge consumer information from the knowledge bank 540 according to the knowledge elements which are retrieved as a search result. The knowledge publisher and/or knowledge consumer information stored in the knowledge bank 540 can include a name, department and contact information of the knowledge publisher and/or knowledge consumer.

The elements of the knowledge automation system 500 as shown in FIG. 5 is merely an example. The elements and arrangement of the elements in the contextualized searcher 520 can vary in accordance with exemplary embodiments.

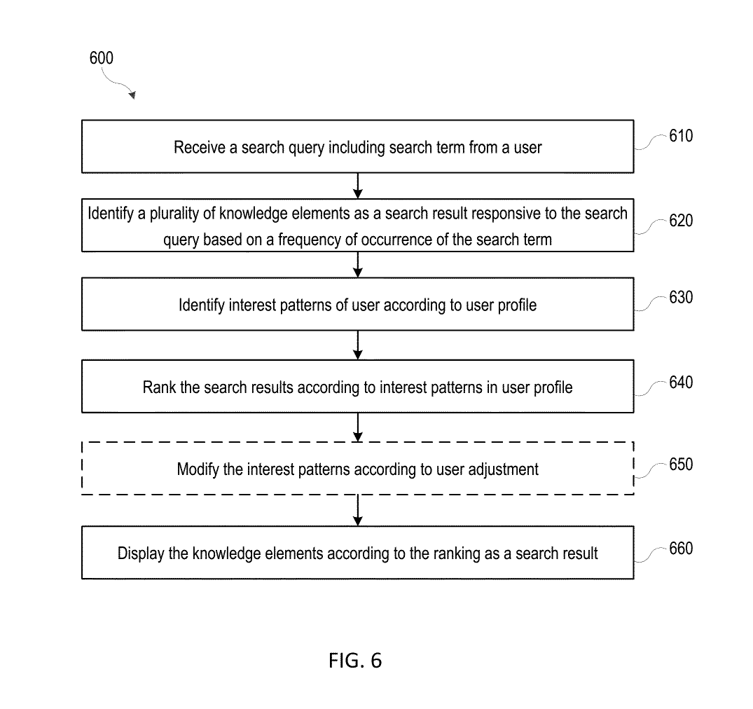

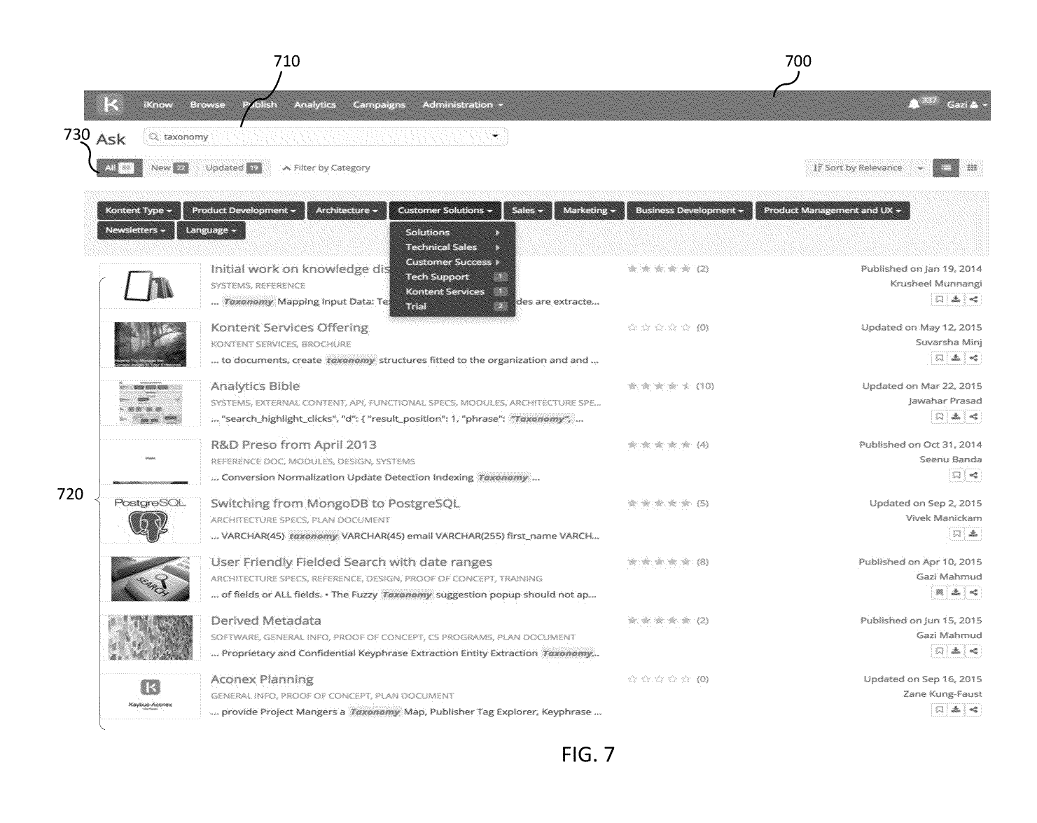

FIG. 6 illustrates a flow diagram of a method 600 of performing a contextual search, according to some exemplary embodiments. FIG. 7 illustrates a graphical user interface 700 displaying a contextual search, according to some exemplary embodiments.

At operation 610, a user can input a search query to the input/output unit 510. For example, as shown in FIG. 7, a user can input a search query for the term “taxonomy” at search box 710. Although a single search term is shown in FIG. 7, a user can use more than one search term. For example, a search query can include several words or a phrase.

In response to receiving the search query, at operation 620, knowledge elements which are directed to the search query are identified. Specifically, knowledge elements that include the search term are identified. The knowledge elements stored in, for example, the knowledge bank, that contain the highest number of instances of the search term can appear in a search result.

A number of knowledge elements which will appear as a search result can be designated by a user. A number of search results can be designated using, for example, filter 730. For example, a user can indicate a maximum of fifty knowledge elements as a search result. Further, the user choose to see all search results related to the search term. When the knowledge elements are identified , the knowledge elements which contain the most instances of the search term will be arranged before knowledge elements which container fewer instances of the search term. That is, the knowledge elements in which the search term appears most frequently will be arranged before knowledge elements in which the search term appears less frequently.

After the knowledge elements that have the highest frequency of the desired search term are identified, at operation 630, the interest patterns of the user are identified. The interest patterns can be identified according to the user's profile. A user's profile can be stored in, for example, profile database 560.

A user's interest patterns (e.g., the content the user typically views) can be identified from the user's profile and used to provide personalized search results to the user. The user interest patterns can include static information as well as dynamic information. Dynamic information can be derived by the knowledge automation system based on prior search queries submitted by the user and knowledge units that the user has consumed. For example, a user's interest patterns with respect to most frequently viewed categories of content, frequently followed content publishers, and most interesting key phrases based on search patterns and content consumption of the user can be machine learned in order to create a user's interest patterns. A user's interest patterns can also include user interests of peers of the user and trending topics among a user's peers.

Further, a user's profile can also indicate content which is not of interest to the user. For example, the knowledge automation system can identify knowledge units and/or knowledge packs which the user does not choose to view or knowledge packs and/or knowledge units that the user only partially views. Therefore, a user's negative sentiment can be machined learned based on the user's interactions with knowledge packs and knowledge units.

In addition, the user's profile can include static user metadata information, such as, a user's location (e.g., city, state, office building), a user's job function, a group the user belongs to, and a user's department.

At operation 640, the knowledge units that were identified in operation 620 can be ranked according to interest patterns of the user that were identified in operation 630. That is, the arrangement of the knowledge elements that were identified in operation 620 can be adjusted taking into account the interest patterns of the user.

Interest patterns can be identified along multiple dimensions. Categories of content, a key term or group of key terms can each be modeled as a user interest dimension. For each identified dimension, a weight can be assigned that indicates the user's interest in that dimension. The weights for each dimension may be further customized by the user, as described below. The search results can be ranked based on weighted fields that correspond with each of the user interest dimensions.

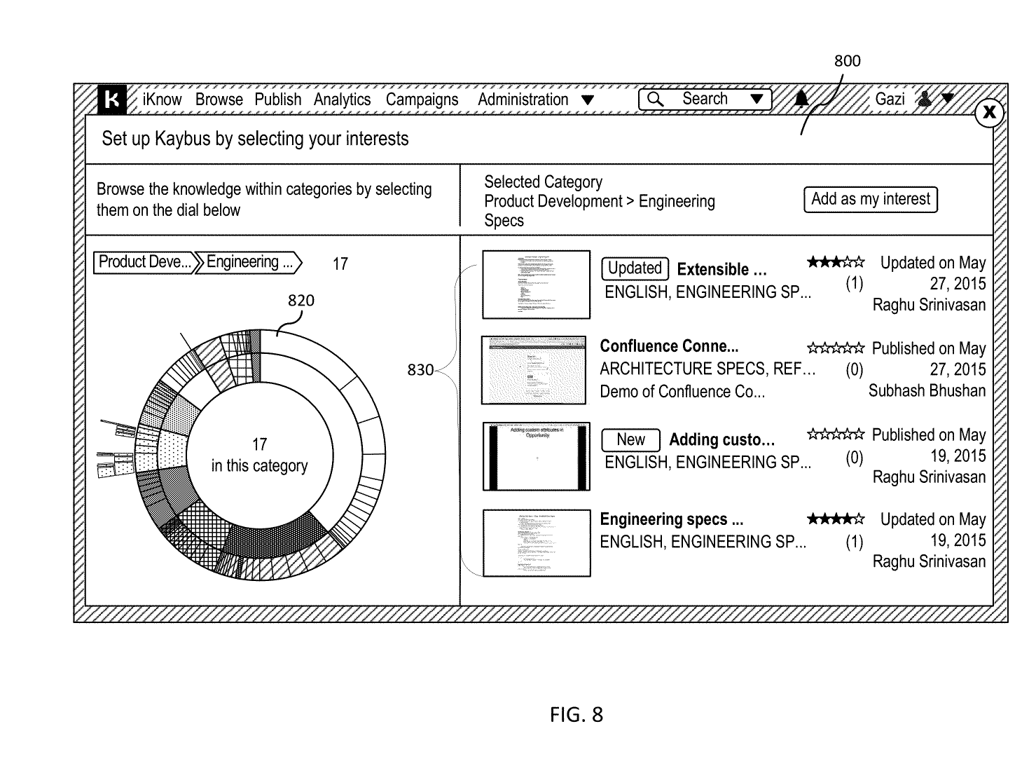

At operation 650, a user can choose to modify their interest patterns. Modification of a user's interest patterns are described in more detail with respect to FIGS. 8, 9 and 10.

At operation 660, the search results can be displayed to a user. As shown in FIG. 7, knowledge elements 720 which include the most instances of the term “taxonomy” can be identified. Field collapsing is performed with the search results, therefore, the knowledge units containing the term “taxonomy” will appear under a knowledge pack to which the knowledge unit belongs. By collapsing the search results, more search results can be provided to a user. For example, although 10,000 knowledge units stored in the knowledge bank contain the term “taxonomy” only 89 search results, that is the knowledge packs that include the 10,000 knowledge units, are provided to the user. However, this is merely an example, and only knowledge units may be provided as a search result.

The search results that are provided to a user contain the most instances of the term and take the user interest patterns into account. Therefore, the search results can be highly relevant to a user. Further, two users with different interest patterns, who search for the same key word may be presented with different results due to their varying interests.

Metadata regarding the user's current search session can also added to the user's profile and stored in, for example, the user's behavioral profile. A user's interest patterns can be continuously updated in the user's profile. Thus, the recommendations reflect real time changes in a user's interests, based on the user's real-time activity, rather than merely predetermined content or what the user was interested in in the past.

### III. Adjusting User Interest Levels

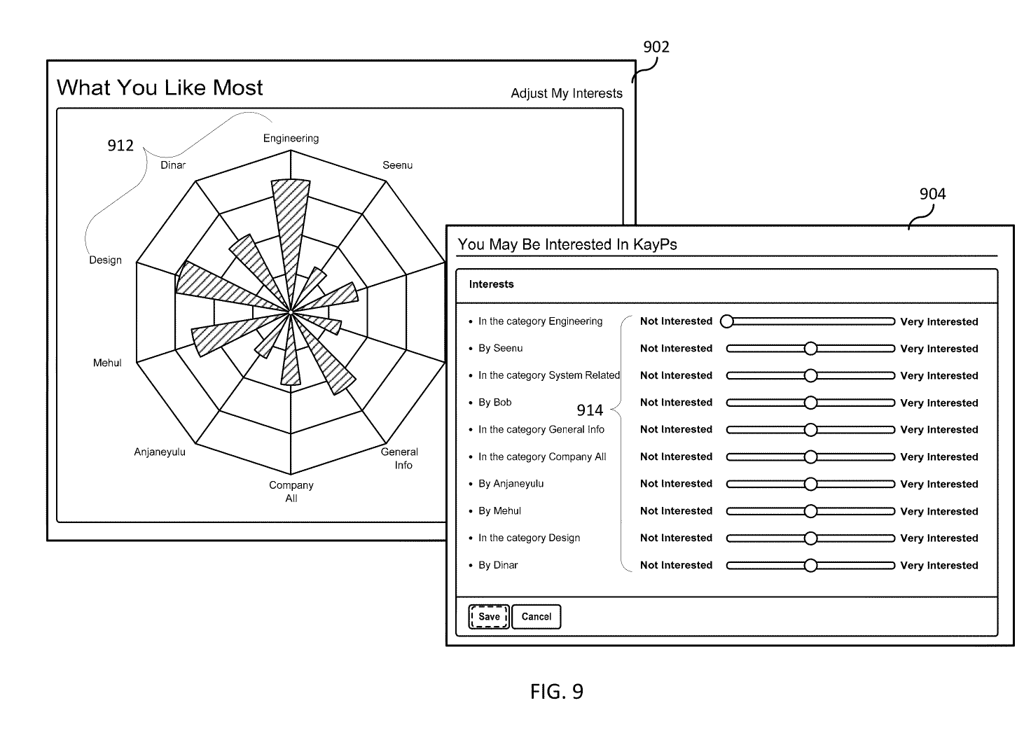

FIG. 8 illustrates a graphical user interface 800 for selecting user interest levels, according to some exemplary embodiments. FIG. 9 illustrates a diagram of a user's interest level in identified content 902 and a graphical user interface for adjusting the interest levels 904, according to some exemplary embodiments.

A user's interest levels can be determined by a knowledge automation system according to the user's interest patterns. However, a user may not agree with the interest levels determined by the knowledge automation system or the user may desire to change the interest levels determined by the knowledge automation system. For example, a user may desire to change the interest levels if the search results being provided do not contain information desired by a user. Prior to performing a search, such as during setup, or after a search has been performed, a user can adjust their interest level regarding particular categories.

As shown in FIG. 8, if a user has not previously set up their interest levels, a graphical user interface (GUI) 800 can be displayed. As shown in GUI 800, a user can indicate by, for example, selecting categories of content on a dial 820, areas of knowledge which are of interest of the user.

The user can adjust the dial 820 according to, for example, preferred categories of knowledge, preferred knowledge publishers of content, and/or preferred key terms. The user can also indicate areas which are not of interest to the user. For example, the user can indicate categories, knowledge publishers, and key terms which are not of interest to the user.

Knowledge elements 830 which match the user's categories of interest can be displayed. Therefore, a user can determine if the knowledge categories that the user has selected vial dial 820 will provide knowledge elements which are of interest to the user. If the knowledge elements 830 which appear on the GUI 800 are not of interest to the user, then the user can adjust dial 820.

Although the description of the GUI 800 has been described with respect to initially setting a user's interests, the GUI 800 can also be used after set up of user interests has already been performed. For example, the GUI 800 can be used to adjust user interests in categories before or after a search is being performed.

As shown in FIG. 9, user interests can be modeled based on the user's activity. For example, the knowledge automation system may determine a user's interest based on topics, categories, and/or key terms associated with knowledge elements that the user has consumed, and/or authors or knowledge publishers that are regularly followed by the user. For example, if the user accesses and views knowledge packs published by a certain knowledge publisher, the user model will reflect an interest in that publisher. Similarly, interests may be modeled based on categories of content. For example, if the user frequently accesses and consumes knowledge packs in the engineering category, then the user model will reflect an interest in engineering material.

Categories of content, a key term or group of key terms can be modeled as a dimension. The frequency of occurrence for a key term or group of key terms can be modeled as another dimension. Concept or concepts covered by the knowledge unit can be modeled as a further dimension. Other metadata such as author or source of the knowledge unit can each be modeled as other dimensions, etc. As shown in FIG. 9 dimensions 912 can include “Design,” “Dinar,” “Engineering,” “Seenu,” “Mehul,” etc. Thus, each knowledge unit can be modeled as vector in n-dimensional space. The similarity between two knowledge units can then be determined by computing a Euclidean distance in n-dimensional space between the end points of the two vectors representing the two knowledge units.

In some embodiments, certain dimensions may be weighted differently than other dimensions. For example, the dimension representing key terms in a knowledge unit can be weighted more heavily than the dimensions representing metadata in the Euclidean distance computation (e.g., by including a multiplication factor for the key term dimension in the Euclidean distance computation). In some embodiments, certain attributes of the knowledge unit (e.g., author, etc.) can also be masked such that the underlying attribute is not included in the Euclidean distance computation.

Knowledge elements consumed by a user may also be analyzed, e.g., based on key terms, to identify additional dimensions of interest for a user. In addition to automatically identifying a user's interests based on their user profile, a graphical user interface 904 may be provided to the user to manually adjust their interest levels for interests of the user identified by the knowledge automation system.

The sliders 914 depicted in FIG. 9 allow a user to manually adjust their level of interest. The adjusted level of interest can be taken into account to improve the knowledge mapping performed by the knowledge automation system. For example, if the user adjusts the interest level of an interest to “Not Interested,” the weight of that key term used in the matching algorithm can be reduced or the key term be eliminated. If the user adjusts the interest level of an interest to “Very Interested,” the weight of that key term used in the matching algorithm can be increased. Therefore, positive dimensions (i.e. terms which a user is interested in) and negative dimensions (terms that a user is not interested in) are taking into account in providing a search result to a user.

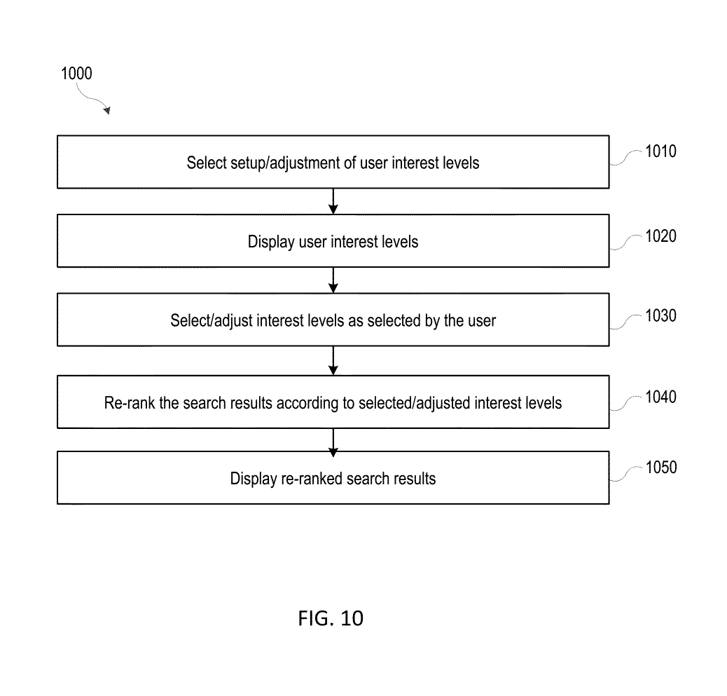

FIG. 10 illustrates a flow diagram of a method 1000 of adjusting user interest levels, according to some exemplary embodiments. The flow diagram of FIG. 10 describes operation 650 of FIG. 6 in more detail.

At operation 1010, a user can choose to set up their user interest levels, as shown in FIG. 8, or a user can adjust their interest levels, as shown in FIG. 9. Therefore, a user can select display of, for example, GUI 800 or GUI 904, in order to setup or adjust the user's interest levels in particular categories.

At operation 1020, the interest levels can be displayed to a user. For example, as shown in FIG. 8, a dial 820 can be displayed which indicates a user's interest levels in particular categories. Alternatively, as shown in FIG. 9, user interests can be displayed as dimensions 912 in the display of the user's interest level in identified content 902.

At operation 1030, the user can set up or adjust their user interest levels. For example, as shown in FIG. 8, the user can adjust the dial 820 according to the user's interest in particular categories. Alternatively, as shown in FIG. 9, a user can adjust slider 914 on GUI 904 in order to adjust the user's interest levels in particular dimensions or categories of interest.

At operation 1040, search results, such as the search results obtained in operation of 640 of FIG. 6, will then be re-ranked according to the interest levels that were set up or adjusted by the user. If the user has not previously set up the user's interest levels, then any future search results will take into account the interest levels that were set by the user. If the user has adjusted the user's interest levels, then any future search results can be adjusted according to the adjustments made by the user.

At operation 1050, the search results, which take into account the user interest levels that were set up or adjusted by the user, can be displayed in a search result.

### IV. Identifying Experts

When a user performs a search for a particular search term or for particular subject matter, they may also want information regarding users who are experts regarding that particular search term or subject matter. Specifically, the search results that are provided to a user may not be adequate or the user may need additional information or clarification. Therefore, in an exemplary embodiment, information regarding experts on a particular search term or subject matter can be provided to a user with the search results. An expert can include a user or a group of users who have published knowledge elements or who have consumed knowledge elements.

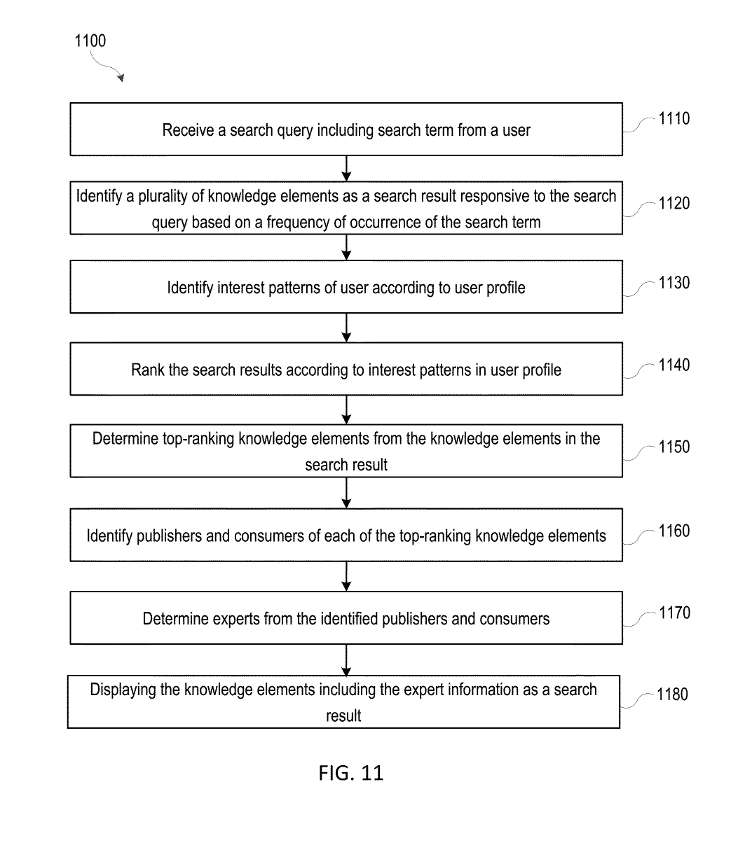

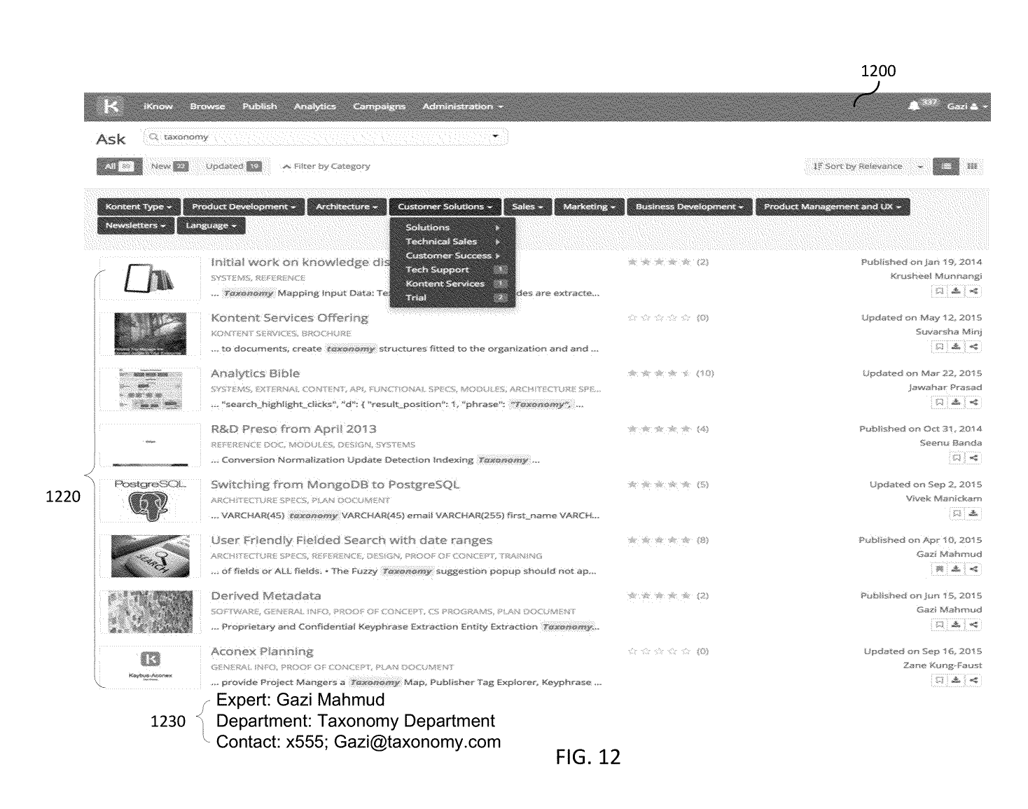

FIG. 11 illustrates a flow diagram of a method of performing a contextual search including expert information, according to some exemplary embodiments. FIG. 12 illustrates a graphical user interface displaying knowledge entities including expert information, according to some exemplary embodiments. Operations 1110, 1120,1130 and 11140 are similar to operations 610, 620, 630, and 640, respectively, of FIG. 6.

At operation 1110, a user can input a search query to the input unit 521. For example, as shown in FIG. 12, a user can input a search query for the term “taxonomy.” The contextualized searcher may be built to include expert information in the search results. Alternatively, the user may set the contextualized searcher to include expert information in the search results.

In response to receiving the search query, at operation 1120, knowledge elements which are directed to the search query are identified. Specifically, knowledge elements that include the search term are identified. The knowledge elements that contain the most instances of the search term can be ranked higher than knowledge elements which contain fewer instances of the search term. For example, with respect to the example described in FIG. 12, knowledge elements which include the most instances of the term “taxonomy” can be identified.

After the knowledge elements containing the desired search term are identified, at operation 1130, the interest patterns of the user are identified. The interest patterns can be identified according to the user's profile.

At operation 1140, the knowledge elements that were determined in operation 1120 can be ranked according to interest patterns of the user.

At operation 1150, the top-ranking knowledge elements of the ranked knowledge elements are determined. The top-ranking knowledge elements can be, for example, the top ten knowledge elements in the search result or the top 10% knowledge elements of a search result. The quantify of top-ranking knowledge elements that are provided to a user can be adjusted according to user search parameters. Alternatively, a quantity of top-ranking knowledge elements can be predefined in the contextualized searcher.

At operation 1160, a knowledge publisher and/or knowledge consumer of each of the top-ranking knowledge elements is identified. For example, expert determiner 525 of the knowledge automation system can determine information (e.g., name, department, etc.) regarding users who have published the top ranking knowledge elements (i.e. knowledge publishers), and/or users who have consumed the top-ranking knowledge elements (i.e. knowledge consumers).

At operation 1170, one or more experts are identified from the knowledge publishers and knowledge consumers identified at operation 1160. An expert can be a knowledge publisher or a knowledge consumer who has published or consumed a threshold number of the top-ranking knowledge elements. For example, if there are 30 top-ranking knowledge elements and a threshold number is defined as “5,” then a knowledge publisher and/or knowledge consumer who has published or consumed 5 or more of the 30 top-ranking knowledge elements can be identified as an expert.

Alternatively, an expert can be a knowledge publisher or a knowledge consumer who has published or consumed a top quantity of the top-ranking knowledge elements. For example, if a top quantity is defined as “10”, and there are 30 top-ranking knowledge elements, then the knowledge publishers and/or the knowledge consumers of the first or top 10 knowledge elements of the 30 top-ranking knowledge elements, can be identified as an expert. The expert information can be retrieved from the knowledge bank.

At operation 1180, the search results can be displayed to a user. The search results that are provided to a user contain the most instances of the term and take into account the user interest patterns. Further, the search results include expert information 1230. The expert information 1230 can include information on the knowledge publishers and/or knowledge consumers who have been identified as experts. The expert information 1230 can include, for example, the name, contact information, and department of the user or users who are identified as experts.

Therefore, if the information on a particular search term is not sufficient to a user, or if the user needs clarification or assistance, they can easily contact the knowledge publishers or knowledge consumers who have been identified as experts in order to obtain additional information.

### V. Computer System

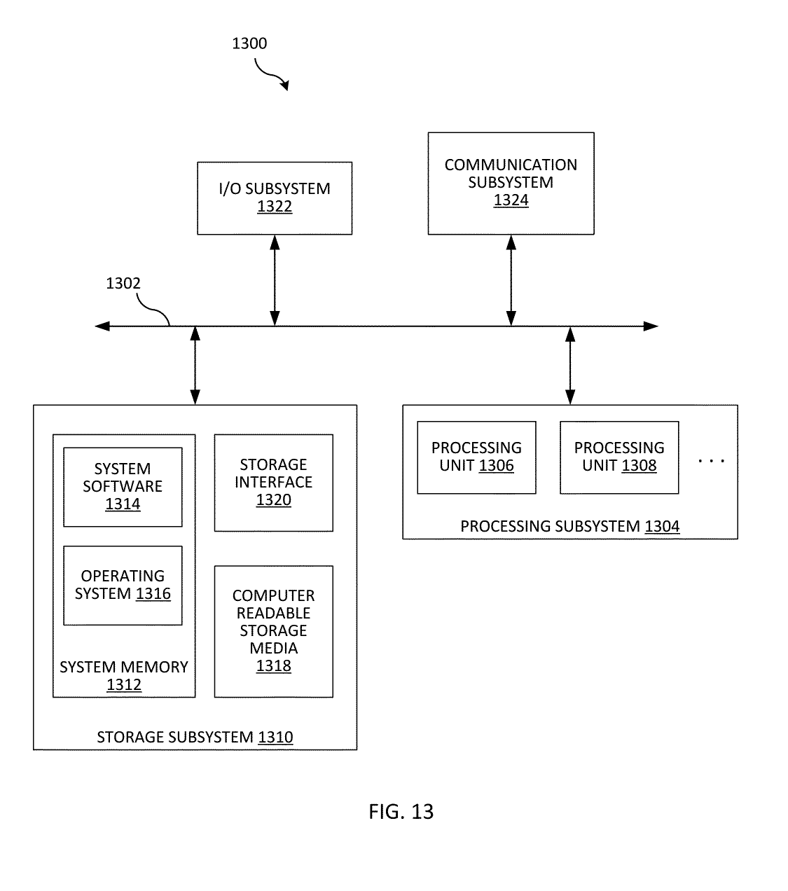

FIG. 13 depicts a block diagram of a computing system 1300, in accordance with some exemplary embodiments. Computing system 1300 can include a communications bus 1302 that connections one or more subsystems, including a processing subsystem 1304, storage subsystem 1310, I/O subsystem 1322, and communication subsystem 1324.

In some embodiments, processing subsystem 1308 can include one or more processing units 1306, 1308. Processing units 1306, 1308 can include one or more of a general purpose or specialized microprocessor, FPGA, DSP, or other processor. In some embodiments, processing unit 1306, 1308 can be a single core or multicore processor.

In some embodiments, storage subsystem can include system memory 1312 which can include various forms of non-transitory computer readable storage media, including volatile (e.g., RAM, DRAM, cache memory, etc.) and non-volatile (flash memory, ROM, EEPROM, etc.) memory. Memory may be physical or virtual. System memory 1312 can include system software 1314 (e.g., BIOS, firmware, various software applications, etc.) and operating system data 1316. In some embodiments, storage subsystem 1310 can include non-transitory computer readable storage media 1318 (e.g., hard disk drives, floppy disks, optical media, magnetic media, and other media). A storage interface 1320 can allow other subsystems within computing system 1300 and other computing systems to store and/or access data from storage subsystem 1310.

In some embodiments, I/O subsystem 1322 can interface with various input/output devices, including displays (such as monitors, televisions, and other devices operable to display data), keyboards, mice, voice recognition devices, biometric devices, printers, plotters, and other input/output devices. I/O subsystem can include a variety of interfaces for communicating with I/O devices, including wireless connections (e.g., Wi-Fi, Bluetooth, Zigbee, and other wireless communication technologies) and physical connections (e.g., USB, SCSI, VGA, SVGA, HDMI, DVI, serial, parallel, and other physical ports).

In some embodiments, communication subsystem 1324 can include various communication interfaces including wireless connections (e.g., Wi-Fi, Bluetooth, Zigbee, and other wireless communication technologies) and physical connections (e.g., USB, SCSI, VGA, SVGA, HDMI, DVI, serial, parallel, and other physical ports). The communication interfaces can enable computing system 1300 to communicate with other computing systems and devices over local area networks wide area networks, ad hoc networks, mesh networks, mobile data networks, the internet, and other communication networks.

In certain embodiments, the various processing performed by a knowledge modeling system as described above may be provided as a service under the Software as a Service (SaaS) model. According this model, the one or more services may be provided by a service provider system in response to service requests received by the service provider system from one or more user or client devices (service requestor devices). A service provider system can provide services to multiple service requestors who may be communicatively coupled with the service provider system via a communication network, such as the Internet.

In a SaaS model, the IT infrastructure needed for providing the services, including the hardware and software involved for providing the services and the associated updates/upgrades, is all provided and managed by the service provider system. As a result, a service requester does not have to worry about procuring or managing IT resources needed for provisioning of the services. This significantly increases the service requestor's access to these services in an expedient manner at a much lower cost point.

In a SaaS model, services are generally provided based upon a subscription model. In a subscription model, a user can subscribe to one or more services provided by the service provider system. The subscriber can then request and receive services provided by the service provider system under the subscription. Payments by the subscriber to providers of the service provider system are generally done based upon the amount or level of services used by the subscriber.

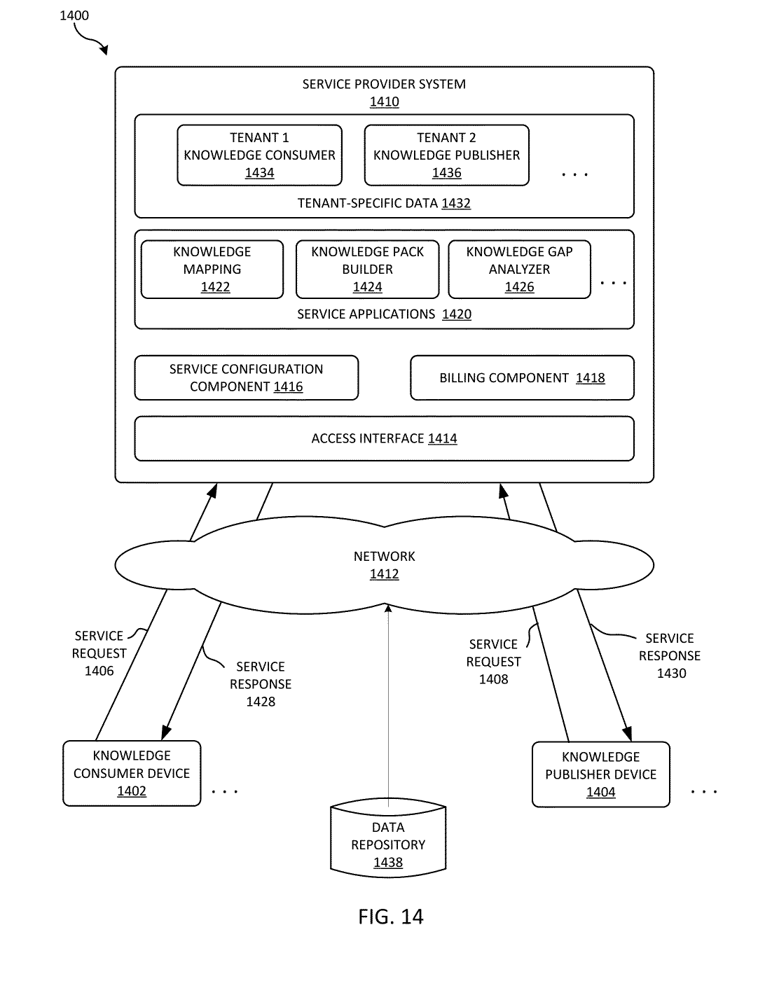

FIG. 14 depicts a simplified block diagram of a service provider system 1400, in accordance with some exemplary embodiments. In the embodiment depicted in FIG. 14, service requestor devices 1404 and 1404 (e.g., knowledge consumer device and/or knowledge publisher device) are communicatively coupled with service provider system 1410 via communication network 1412. In some embodiments, a service requestor device can send a service request to service provider system 1410 and, in response, receive a service provided by service provider system 1410. For example, service requestor device 1402 may send a request 1406 to service provider system 1410 requesting a service from potentially multiple services provided by service provider system 1410. In response, service provider system 1410 may send a response 1428 to service requestor device 1402 providing the requested service. Likewise, service requestor device 1404 may communicate a service request 1408 to service provider system 1410 and receive a response 1430 from service provider system 1410 providing the user of service requestor device 1404 access to the service. In some embodiments, SaaS services can be accessed by service requestor devices 1402, 1404 through a thin client or browser application executing on the service requestor devices. Service requests and responses 1428, 1430 can include HTTP/HTTPS responses that cause the thin client or browser application to render a user interface corresponding to the requested SaaS application. While two service requestor devices are shown in FIG. 14, this is not intended to be restrictive. In other embodiments, more or less than two service requestor devices can request services from service provider system 1410.

Network 1412 can include one or more networks or any mechanism that enables communications between service provider system 1410 and service requestor devices 1402, 1404. Examples of network 1412 include without restriction a local area network, a wide area network, a mobile data network, the Internet, or other network or combinations thereof. Wired or wireless communication links may be used to facilitate communications between the service requestor devices and service provider system 1410.

In the embodiment depicted in FIG. 14, service provider system 1410 includes an access interface 1414, a service configuration component 1416, a billing component 1418, various service applications 1420, and tenant-specific data 1432. In some embodiments, access interface component 1414 enables service requestor devices to request one or more services from service provider system 1410. For example, access interface component 1414 may comprise a set of webpages that a user of a service requestor device can access and use to request one or more services provided by service provider system 1410.

In some embodiments, service manager component 1416 is configured to manage provision of services to one or more service requesters. Service manager component 1416 may be configured to receive service requests received by service provider system 1410 via access interface 1414, manage resources for providing the services, and deliver the services to the requesting requesters. Service manager component 1416 may also be configured to receive requests to establish new service subscriptions with service requestors, terminate service subscriptions with service requestors, and/or update existing service subscriptions. For example, a service requestor device can request to change a subscription to one or more service applications 1422-1426, change the application or applications to which a user is subscribed, etc.).

Service provider system 1410 may use a subscription model for providing services to service requestors according to which a subscriber pays providers of the service provider system based upon the amount or level of services used by the subscriber. In some embodiments, billing component 1418 is responsible for managing the financial aspects related to the subscriptions. For example, billing component 1410, in association with other components of service provider system 1410, may be configured to determine amounts owed by subscribers, send billing statements to subscribers, process payments from subscribers, and the like.

In some embodiments, service applications 1420 can include various applications that provide various SaaS services. For example, one more applications 1420 can provide the various functionalities described above and provided by a knowledge modeling system.

In some embodiments, tenant-specific data 1432 comprises data for various subscribers or customers (tenants) of service provider system 1410. Data for one tenant is typically isolated from data for another tenant. For example, tenant 1's data 1434 is isolated from tenant 2's data 1436. The data for a tenant may include without restriction subscription data for the tenant, data used as input for various services subscribed to by the tenant, data generated by service provider system 1410 for the tenant, customizations made for or by the tenant, configuration information for the tenant, and the like. Customizations made by one tenant can be isolated from the customizations made by another tenant. The tenant data may be stored service provider system 1410 (e.g., 1434, 1436) or may be in one or more data repositories 1438 accessible to service provider system 1410.

It should be understood that the methods and processes described herein are exemplary in nature, and that the methods and processes in accordance with some embodiments may perform one or more of the steps in a different order than those described herein, include one or more additional steps not specially described, omit one or more steps, combine one or more steps into a single step, split up one or more steps into multiple steps, and/or any combination thereof.

It should also be understood that the components (e.g., functional blocks, modules, units, or other elements, etc.) of the devices, apparatuses, and systems described herein are exemplary in nature, and that the components in accordance with some embodiments may include one or more additional elements not specially described, omit one or more elements, combine one or more elements into a single element, split up one or more elements into multiple elements, and/or any combination thereof.

Although specific exemplary embodiments have been described, various modifications, alterations, alternative constructions, and equivalents are also encompassed within the scope of the exemplary embodiments. The exemplary embodiments are not restricted to operation within certain specific data processing environments, but are free to operate within a plurality of data processing environments. Additionally, although exemplary embodiments have been described using a particular series of transactions and steps, it should be apparent to those skilled in the art that the scope of the exemplary embodiments is not limited to the described series of transactions and steps. Various features and aspects of the above-described embodiments may be used individually or jointly.

Further, while exemplary embodiments have been described using a particular combination of hardware and software, it should be recognized that other combinations of hardware and software are also within the scope of the exemplary embodiments. Exemplary embodiments may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter-process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific exemplary embodiments have been described, these are not intended to be limiting. Various modifications and equivalents are within the scope of the following claims. For example, one or more features from any exemplary embodiment may be combined with one or more features of any other exemplary embodiment.

What is claimed is:

1. A method comprising:
receiving, by a data processing system, a search query including a search term from a user;
in response to receiving the search query, identifying, by the data processing system, a plurality of knowledge elements as a search result to the search query based on a frequency of occurrence of the search term in each knowledge element;
identifying user interest patterns of the user, wherein the user interest patterns include static information and dynamic information,
wherein the dynamic information is dynamically derived by the data processing system based on prior search queries submitted by the user and knowledge elements that the user has consumed, and wherein the user interest patterns are stored in a user profile associated with the user;
ranking, by the data processing system, the plurality of knowledge elements based on the user interest patterns stored in the user profile associated with the user; and
displaying the plurality of knowledge elements according to the ranking as the search result.

2. The method of claim 1, further comprising:
determining a plurality of top-ranking knowledge elements from the plurality of knowledge elements in the search result;
identifying one or more knowledge publishers of each of the plurality of top- ranking knowledge elements;
determining, from the identified knowledge publishers, one or more experts of knowledge associated with the search term of the search query; and
displaying the one or more experts with the search result.

3. The method of claim 2, wherein an identified knowledge publisher is determined to be an expert when the identified knowledge publisher has published a threshold number of the top-ranking knowledge elements.

4. The method of claim 1, further comprising:
determining a plurality of top-ranking knowledge elements from the plurality of knowledge elements in the search result;
identifying one or more knowledge consumers of each of the plurality of top- ranking knowledge elements; and
determining, from the identified knowledge consumers, one or more experts of knowledge associated with the search term of the search query; and
displaying the one or more experts with the search result.

5. The method of claim 4, wherein an identified knowledge consumer is determined to be an expert when the identified knowledge consumer has consumed a threshold number of the top-ranking knowledge elements.

6. The method of claim 1, wherein the user interest patterns include key terms of interest to the user and knowledge publishers of interest to the user derived by the data processing system.

7. The method of claim 6, further comprising:
displaying a graphical user interface that allows a user to adjust an interest level for each of the key terms of interest and knowledge publishers of interest to the user.

8. The method of claim 6, wherein the user interest patterns further include key terms of interest to peer users of the user, and knowledge publishers of interest to the peer users of the user derived by the data processing system.

9. The method of claim 1, wherein the plurality of knowledge elements include one or more knowledge units.

10. The method of claim 9, wherein the plurality of knowledge elements include one or more knowledge packs of the one or more knowledge units.

11. The method of claim 1, further comprising updating the interest patterns of the user that are stored in the user profile after the search is performed.

12. The method of claim 1, wherein the user interest patterns comprise negative sentiment information regarding knowledge elements that are not of interest to the user, and
wherein the negative sentiment information is derived by the data processing system.

13. The method of claim 1, wherein the static information comprises user metadata including one of a user location, a user job function, a user group, and a user department.

14. A non-transitory computer-readable storage medium storing a plurality of instructions executable by one or more processors, the plurality of instructions comprising:
receiving a search query including a search term from a user;
in response to receiving the search query, identifying a plurality of knowledge elements as a search result to the search query based on a frequency of occurrence of the search term in each knowledge element;
identifying user interest patterns of the user, wherein the user interest patterns include static information and dynamic information,
wherein the dynamic information is dynamically derived by the data processing system based on prior search queries submitted by the user and knowledge elements that the user has consumed, and wherein the user interest patterns are stored in a user profile associated with the user;
ranking the plurality of knowledge elements based on the user interest patterns stored in the user profile associated with the user; and
displaying the plurality of knowledge elements according to the ranking as the search result.

15. The computer-readable storage medium of claim 14, wherein the plurality of instructions further comprise:
determining a plurality of top-ranking knowledge elements from the plurality of knowledge elements in the search result;
identifying one or more knowledge publishers of each of the plurality of top- ranking knowledge elements; and
determining, from the identified knowledge publishers, one or more experts of knowledge associated with the search term of the search query; and
displaying the one or more experts with the search result.

16. The computer-readable storage medium of claim 15, wherein an identified knowledge publisher is determined to be an expert when the identified knowledge publisher has published a threshold number of the top-ranking knowledge elements.

17. The computer-readable storage medium of claim 14, wherein the plurality of instructions further comprise updating the interest patterns of the user that are stored in the user profile after the search is performed.

18. The computer-readable storage medium of claim 14, wherein the user interest patterns comprise negative sentiment information regarding knowledge elements that are not of interest to the user, and
wherein the negative sentiment information is derived by the data processing system.

19. A system comprising:
one or more processors; and
a memory coupled with and readable by the one or more processors, the memory configured to store a set of instructions which, when executed by the one or more processors, causes the one or more processors to:
receive a search query including a search term from a user;
in response to receiving the search query, identify a plurality of knowledge elements as a search result to the search query based on a frequency of occurrence of the search term in each knowledge element;
identify user interest patterns of the user, wherein the user interest patterns include static information and dynamic information,
wherein the dynamic information is dynamically derived by the data processing system based on prior search queries submitted by the user and knowledge elements that the user has consumed, and wherein the user interest patterns are stored in a user profile associated with the user;
rank the plurality of knowledge elements based on the user interest patterns stored in the user profile associated with the user; and
display the plurality of knowledge elements according to the ranking as the search result.

20. The system of claim 19, further comprising causing the one or more processors to:
determine a plurality of top-ranking knowledge elements from the plurality of knowledge elements in the search result;
identify one or more knowledge publishers of each of the plurality of top-ranking knowledge elements;
determine, from the identified knowledge publishers, one or more experts of knowledge associated with the search term of the search query; and
display the one or more experts with the search result.
